(19) United States
(12) Patent Application Publication
(10) Pub. No.: US 2012/0054154 A1
(43) Pub. Date: Mar. 1, 2012

(54) USER DATA MANAGEMENT SYSTEM AND METHOD

(75) Inventors: TENG-YU TSAI, Tu-Cheng (TW); KAI-HO HSIUNG, Tu-Cheng (TW); SHIAU-LUEN CHEN, Tu-Cheng (TW); TUN-TAO TSAI, Tu-Cheng (TW); TENG-SHENG YU, Tu-Cheng (TW)

(73) Assignee: HON HAI PRECISION INDUSTRY CO., LTD., Tu-Cheng (TW)

(21) Appl. No.: 13/155,714

(22) Filed: Jun. 8, 2011

(30) Foreign Application Priority Data
Aug. 30, 2010 (CN) 201010266865.4

(51) Int. Cl. G06F 7/00

(52) U.S. Cl. 707/638; 707/E17.044; 707/E17.005

(57) ABSTRACT

A user data management system of an electronic device includes a version database, a reading module, a version obtaining module, a change listing module, an adjusting module, and a saving module. The version database stores version change history for user data. The reading module reads the current user data from a source. The version obtaining module obtains the current version of the current user data, and obtains the latest version of user data from the version database. The change listing module retrieves changes between the current version and the latest version from the version database. The adjusting module applies the changes to the current user data and adjusts the current version of the current user data to the latest version. The saving module saves the current user data to the source.

### BACKGROUND

1. Technical Field

The disclosure generally relates to a user data management system and a method.

2. Description of Related Art

In computer programming, user data is generated by an application for one or more users. The user data may include a user profile, user history, environment variables, and preferred settings. The more times a user uses an application, the more valuable the user data generated by the application is likely to be. However, if the application is upgraded to a newer version, the user data generated by older versions of the application may be not compatible with the newer versions of the application.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of one embodiment of a user data management system installed in an electronic device.

FIG. 2 is a flowchart of a user data management method using the user data management system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming languages such as Java, C, or Assembly. One or more software instructions in the modules may be embedded in firmware, such as an EPROM. Modules may comprise connected logic units, such as gates and flip-flops, and programmable units such as programmable gate arrays or processors. The modules described herein may be implemented as software and/or hardware modules and may be stored in any type of computer-readable medium or other computer storage device.

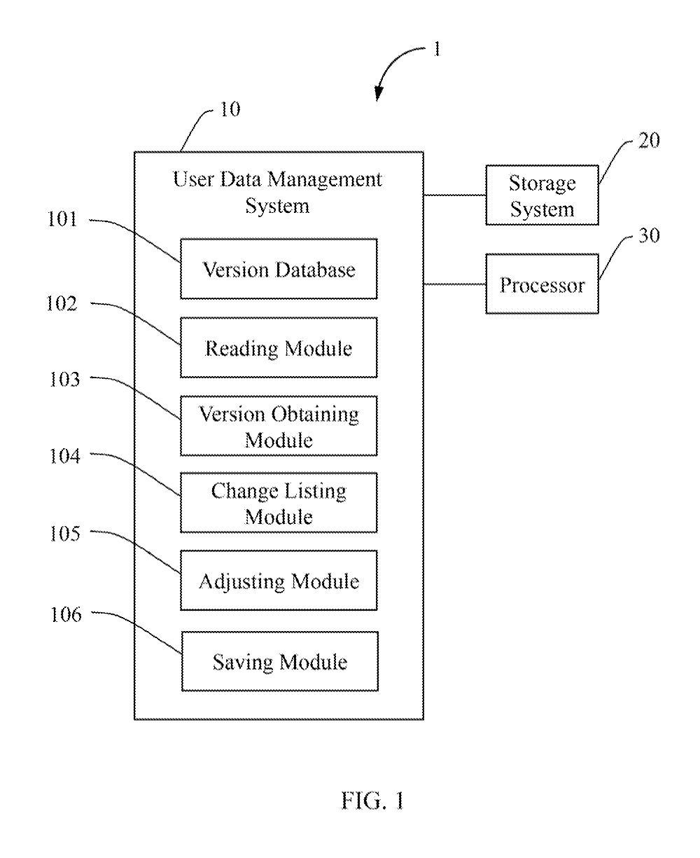

FIG. 1 is a schematic diagram of one embodiment of an electronic device 1. In the embodiment, the electronic device 1 may include a user data management system 10, a storage system 20, and at least one processor 30. The user data management system 10 may manage user data generated by an application in the electronic device 1.

In one embodiment, the storage system 20 may be a magnetic or an optical storage system, such as a hard disk drive, an optical drive, or a tape drive. The storage system 20 stores corresponding user data generated by an application in the electronic device 1. The user data may include a plurality of user data items. Each user data item records a specific field of data. For example, a user data item may comprise a user name, or an email address. In one embodiment, the user data may include a version data item for indicating the version of the user data.

In one embodiment, the user data management system 10 includes a version database 101, a reading module 102, a version obtaining module 103, a change listing module 104, an adjusting module 105 and a saving module 106. Each of the modules 101-106 may be a software program including one or more computerized instructions that are stored in the storage system 20 and executed by the processor 30.

The version database 101 stores version change history for user data. In general, the version change history includes a plurality of change items. A change log may record an addition of a user data item, a deletion of a user data item, or a modification of a user data item. Each change item includes a plurality of change logs associated with a version updated from a prior version. For example, a version change history may read as follows:

### [Change Item #1]

### [Version=1.01]

[ChangeLog#1=Add a new user data item“Username”]
[ChangeLog#2=Add a new user data item“Email”]
[ChangeLog#3=Detele the user data item“Alias”]

### [Change Item #2]

### [Version=1.03]

[ChangeLog#1=Delete the user data item“Username”]
[ChangeLog#2=Add a new user data item“PostCode”]

### [Change Item #3]

### [Version=1.07]

[ChangeLog#1=Delete the user data item“Postcode”]
According to the above exemplary change history, there are 3 change items. For change item#2, it records what the version 1.03 of user data is changed in comparison with the prior version (version 1.01 here). Furthermore, the change item#2 includes 2 change logs. Because version numbers increase, the highest version number is usually both the newest and latest version. For example, in the exemplary change history, the newest and latest version is version 1.07.

The reading module 102 reads current user data from a source. The source may be a database, a register, an INI file or an XML file, that is stored in the storage system 20. The reading module 102 may query the storage system 20 for storage space to temporarily store the current user data.

The version obtaining module 103 may obtain the current version of the current user data by reading the version data item from the current user data. The version obtaining module 103 may also obtain the latest version of user data from the version database 101. In one embodiment, the newest version recorded in the version database 101 is the latest version of the user data. The version obtaining module 103 may further determine whether the current version is older than the latest version.

The change listing module 104 may retrieve changes between the current version and the latest version from the version database 101. The change listing module 104 may calculate the number of versions between the current version and the latest version from the version database and obtain a change item for each of these versions. The change listing module 104 may extract change logs from the obtained change items and generate a change list according to the change logs.

The adjusting module 105 may apply the changes to the current user data and adjust the current version of the current user data to the latest version. In one embodiment, the adjusting module 105 may fetch each change log from the change list in order from older version to newer version. If the current version is newer than or equal to the latest version, there is no need to update the current user data. Otherwise, the system find changes between the current version and the latest one and apply the changes to the current version. If the change log records an addition of a user data item, the adjusting module 105 adds this user data item to the current user data. If the change log records a deletion of a user data item, the adjusting module 105 deletes this user data item from the current user data. In some embodiments, if the change log records a deletion of a user data item, the adjusting module 105 may invalidate this user data item by adding an invalidation mark to this user data item to the current user data. If the change log records a modification of a user data item, the adjusting module 105 modifies the user data item in the current user data.

The saving module 106 is used to save the current user data to the source.

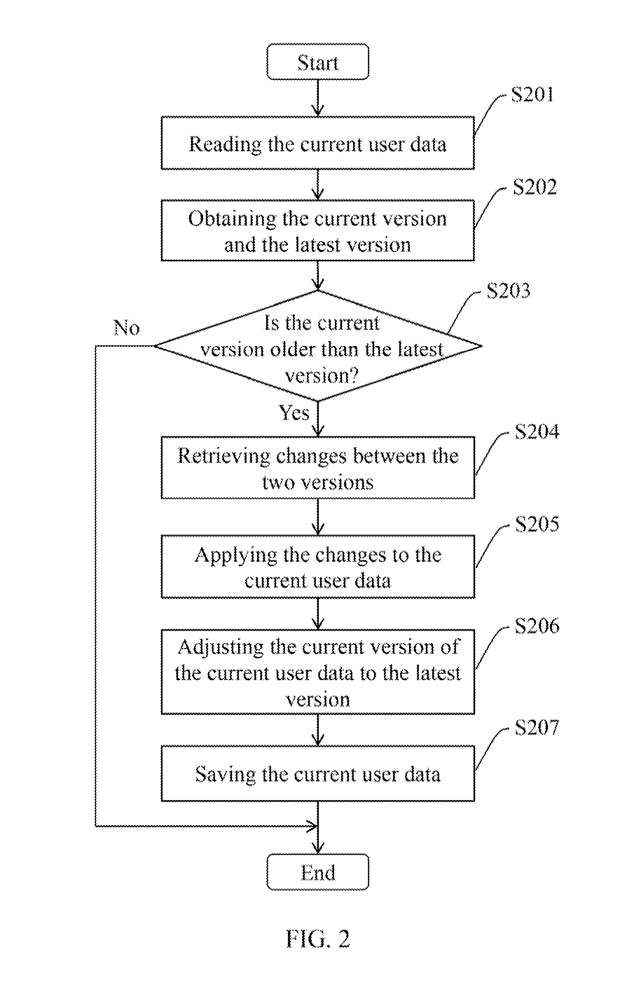

FIG. 2 is a flowchart illustrating one embodiment of a user data management method using the user data management system of FIG. 1. The method may include the following blocks.

In block S201, the reading module 102 reads current user data from a source.

In block S202, the version obtaining module 103 obtains the current version of the current user data by reading the version data item from the current user data and obtains the latest version of user data from the version database 101.

In block S203, the version obtaining module 103 determines whether the current version is older than the latest version. If the current version is older than the latest version, then the flow goes to block S204. If the current version is newer than or equal to the latest version, the flow ends.

In block S204, the change listing module 104 retrieves changes between the current version and the latest version from the version database 101. The change listing module 104 calculates versions between the current version and the latest version from the version database and obtains change item for each of these versions. Then the change listing module 104 extracts change logs from the obtained change items and generates a change list according to the change logs.

In block S205, the adjusting module 105 applies the changes to the current user data. In one embodiment, the adjusting module 105 fetches each change log from the change list in order from older version to newer version. If the change log records an addition of a user data item, the adjusting module 105 adds this user data item to the current user data. If the change log records a deletion of a user data item, the adjusting module 105 deletes this user data item from the current user data. In some embodiments, if the change log records a deletion of a user data item, the adjusting module 105 invalidates this user data item by adding an invalidation mark to this user data item in the current user data. If the change log records a modification of a user data item, the adjusting module 105 modifies the user data item in the current user data.

In block S206, the adjusting module 105 adjusts the current version of the current user data to the latest version.

In block S207, the saving module 106 saves the current user data to the source.

Depending on the embodiment, certain steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A user data management method of an electronic device, comprising:
providing a version database for storing version change history for user data;
reading current user data from a source;
obtaining current version of the current user data and latest version of user data from the version database;
retrieving changes between the current version and the latest version from the version database;
applying the changes to the current user data;
adjusting the current version of the current user data to the latest version; and
saving the current user data to the source.

2. The method of the claim 1, wherein the user data comprises a plurality of user data items.

3. The method of the claim 2, wherein the user data comprises a version data item for indicating the version of the user data.

4. The method of the claim 3, wherein the current version of the current user data is obtained by reading the version data item from the current user data.

5. The method of the claim 2, wherein the version change history comprises a plurality of change items that each change item records at least one change log associated with a version updated from a prior version.

6. The method of the claim 5, wherein the change log records one of an addition of a user data item, a deletion of a user data item, and a modification of a user data item.

7. The method of the claim 6, wherein the block of retrieving changes between the current version and the latest version from the version database comprises:
obtaining change items for versions between the current version and the latest version from the version database;
extracting change logs from the change items; and
generating a change list according to the change logs.

8. The method of the claim 7, wherein the block of applying the changes to the current user data comprises:
fetching each change log from the change list by order of from older version to newer version;
when the change log records an addition of a user data item, adding the user data item to the current user data;
when the change log records a deletion of a user data item, deleting or invalidating the user data item from the current user data; and
when the change log records a modification of a user data item, modifying the user data item in the current user data.

9. The method of the claim 8, wherein the block of invalidating the user data item from the current user data comprises:
adding an invalidation mark to the user data item.

10. A user data management system of an electronic device, comprising:
a version database adapted to store version change history for user data;
a reading module adapted to read current user data from a source;
a version obtaining module adapted to obtain current version of the current user data and latest version of user data from the version database;
a change listing module adapted to retrieving changes between the current version and the latest version from the version database;
an adjusting module adapted to apply the changes to the current user data and adjust the current version of the current user data to the latest version; and
a saving module adapted to save the current user data to the source.

11. The system of the claim 10, wherein the user data comprises a plurality of user data items.

12. The system of the claim 11, wherein the user data comprises a data item for indicating the version of the user data.

13. The system of the claim 11, wherein the version change history comprises a plurality of change items that each change item records at least one change log associated with a version updated from a prior version.

14. The system of the claim 13, wherein the change log records one of an addition of a user data item, a deletion of a user data item, and a modification of a user data item.

15. The system of the claim 13, wherein the change listing module is further adapted to obtain change items for versions between the current version and the latest version from the version database, extract change logs from the change items, and generate a change list according to the change logs.

16. The system of the claim 15, wherein the adjusting module is further adapted to fetch each change log from the change list by order of from older version to newer version.

17. The system of the claim 15, wherein the adjusting module is further adapted to, when the change log records an addition of a user data item, add the user data item to the current user data.

18. The system of the claim 15, wherein the adjusting module is further adapted to, when the change log records a deletion of a user data item, delete the user data item from the current user data.

19. The system of the claim 15, wherein the adjusting module is further adapted to, when the change log records a deletion of a user data item, invalidate the user data item by adding an invalidation mark to the user data item in the current user data.

20. The system of the claim 15, wherein the adjusting module is further adapted to, when the change log records a modification of a user data item, modify the user data item in the current user data.
